(19) United States
(12) Patent Application Publication
(10) Pub. No.: US 2014/0258016 A1
(43) Pub. Date: Sep. 11, 2014

(54) SYSTEM AND METHOD FOR GENERATING RECOMMENDATIONS

(71) Applicants: Tyler James Hale, San Jose, CA (US); Nishant Asthana, San Jose, CA (US); Michael J. Barnes, Santa Cruz, CA (US); Gayathri Ravichandran Geetha, Sunnyvale, CA (US); Eugene Lewis Gunter, San Jose, CA (US); Seyed-Mahdi Pedramrazi, Santa Clara, CA (US); Munawar Saeed, Campbell, CA (US); Khushwant Singh, Dublin, CA (US); Gregory Tariff, San Jose, CA (US); Sachin Tilloo, Fremont, CA (US)

(72) Inventors: Tyler James Hale, San Jose, CA (US); Nishant Asthana, San Jose, CA (US); Michael J. Barnes, Santa Cruz, CA (US); Gayathri Ravichandran Geetha, Sunnyvale, CA (US); Eugene Lewis Gunter, San Jose, CA (US); Seyed-Mahdi Pedramrazi, Santa Clara, CA (US); Munawar Saeed, Campbell, CA (US); Khushwant Singh, Dublin, CA (US); Gregory Tariff, San Jose, CA (US); Sachin Tilloo, Fremont, CA (US)

(73) Assignee: EBAY INC., SAN JOSE, CA (US)

(21) Appl. No.: 14/135,275

(22) Filed: Dec. 19, 2013

Related U.S. Application Data
(60) Provisional application No. 61/775,043, filed on Mar. 8, 2013.

(51) Int. Cl. G06Q 30/06

(52) U.S. Cl. CPC G06Q 30/0631
USPC 705/26.3; 705/26.1; 705/26.7

(57) ABSTRACT

Example methods and systems are directed to generating recommendations based on one or more user inventories, which may be stored in a database. The inventory may include items (e.g., physical goods, electronic goods, and financial assets) owned by a user. A machine may use the database to provide suggestions to the user to buy or sell items. The machine may also use the database to provide suggestions to the user to join a community. The database may be used in conjunction with an electronic commerce site. The machine may be aware of which items in the site are being viewed by the user. The recommendation made by the machine may take into account the item being viewed. The user may be able to view the current market value for each item individually, the total value for a selection of items, or the total value for all items.

### CLAIM OF PRIORITY UNDER 35 U.S.C. §119(e)

The present application claims priority under 35 U.S.C. §119(e) to, and incorporates by reference, U.S. Provisional Application No. 61/775,043, filed Mar. 8, 2013, entitled “SYSTEM AND METHOD FOR GENERATING RECOMMENDATIONS.”

### TECHNICAL FIELD

The subject matter disclosed herein generally relates to processing data. Specifically, the present disclosure addresses systems and methods related to generating recommendations.

### BACKGROUND

An online selling service provides an ability to users to buy and sell items electronically. A buyer may view images of items on a computer screen. The buyer can then select an item to purchase, and payment can be handled electronically (e.g., by credit card or debit card). A seller may be notified when an item is purchased by a buyer and prompted to ship the physical item. An electronic item may not require physical shipment.

### BRIEF DESCRIPTION OF THE DRAWINGS

Some embodiments are illustrated by way of example and not limitation in the figures of the accompanying drawings.

FIG. 1 is a network diagram illustrating a network environment suitable for generating recommendations, according to some example embodiments.

FIG. 2 is a block diagram illustrating components of a server machine suitable for generating recommendations, according to some example embodiments.

FIG. 3 is a flowchart illustrating data flows within the network environment suitable for generating recommendations, according to some example embodiments.

FIG. 4 is a flowchart illustrating data flows within the network environment suitable for generating recommendations, according to some example embodiments.

FIG. 5 is a block diagram illustrating components of a machine, according to some example embodiments, able to read instructions from a machine-readable medium and perform any one or more of the methodologies discussed herein.

FIG. 6 is a user interface diagram illustrating a user interface with information regarding items owned by a user, according to some example embodiments.

FIG. 7 is a user interface diagram illustrating a user interface that may be displayed after a user has added a gadget to their inventory, according to some example embodiments.

FIG. 8 is a user interface diagram illustrating a user interface that prompts a user to add specific items identified as being likely to be owned by the user, according to some example embodiments.

FIG. 9 is a user interface diagram illustrating a user interface that contains information regarding a listing of an item for sale, according to some example embodiments.

FIG. 10 is a user interface diagram illustrating a user interface that includes price trend data, according to some example embodiments.

FIG. 11 is a user interface diagram illustrating a user interface that shows that the user has purchased an item and includes details regarding the item and the transaction, according to some example embodiments.

FIG. 12 is a user interface diagram illustrating a user interface that shows a portion of a user's inventory, according to some example embodiments.

FIG. 13 is a user interface diagram illustrating a user interface that shows information regarding an item from a user's inventory, according to some example embodiments.

FIG. 14 is a user interface diagram illustrating a user interface that shows information about items in a user's inventory, according to some example embodiments.

FIG. 15 is a user interface diagram illustrating a user interface that shows aggregate information regarding a user's inventory and detail information regarding an item in the inventory, according to some example embodiments.

FIG. 16 is a user interface diagram illustrating a user interface showing information regarding an item, according to some example embodiments.

FIG. 17 is a user interface diagram illustrating a user interface with a recommendation that a user sell an item, according to some example embodiments.

FIG. 18 is a user interface diagram illustrating a user interface depicting a showcase, according to some example embodiments.

FIG. 19 is a user interface diagram illustrating a user interface including comments on an item, according to some example embodiments.

FIG. 20 is a user interface diagram illustrating a user interface including a summary of information regarding a user's inventory, according to some example embodiments.

### DETAILED DESCRIPTION

Example methods and systems are directed to generating recommendations. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A database may store information regarding items owned by a user. In some embodiments, a machine uses the database to provide suggestions to the user based on the items owned by the user. For example, instead of a generic message encouraging a user to sell an item on an electronic commerce site, a specific message encouraging the user to sell a particular item known to be owned by the user can be presented. The specific message may be generated based on information about the item as well. For example, if an out-of-print book is about to be made as a movie and the title of the book begins to appear more frequently in the media, the machine may determine that demand for the book is likely to rise and encourage a user owning the book to place it for sale.

In some embodiments, the machine uses the database to provide a suggestion to the user to buy an item based on items owned by the user. For example, instead of a generic message encouraging a user to buy an item on an electronic commerce site, a specific message encouraging the user to buy a particular item known not to be owned by the user can be presented. The specific message may be generated based on information about the item as well. For example, if the user owns the first two books in a series and the third book has just become available, the machine may suggest the third book to the user.

In some embodiments, the machine uses the database to provide suggestions to the user to join a community (e.g., a forum, an email distribution list, a local club, etc.) based on the items owned by the user. For example, an electronic forum dedicated to the topic of Gibson guitars may exist. In this example, after determining that the user owns a Gibson guitar, the machine may suggest that the user join the forum.

In some example embodiments, the database is used in conjunction with an electronic commerce site. In such embodiments, the machine may be aware of which item in the site the user is viewing. Then, the recommendation made by the machine may take into account the item being viewed as well as the items owned by the user. In some example embodiments, the recommendation is based on the user's item viewing history, not merely the item currently being viewed. The machine may make recommendations based on, for example, a price of the item being viewed.

In some example embodiments, the machine presents information about the user's items to the user. For example, the user may be able to organize the items by category. As another example, the user may be able to view the current market value for each item individually, the total value for a selection of items, or the total value for all items.

In some example embodiments, the machine accesses information about the user's financial assets (e.g., stocks, bonds, savings accounts, checking accounts, or other liquid instruments). In some example embodiments, buy or sell recommendations are based on the user's financial assets as well as the set of items owned by a user.

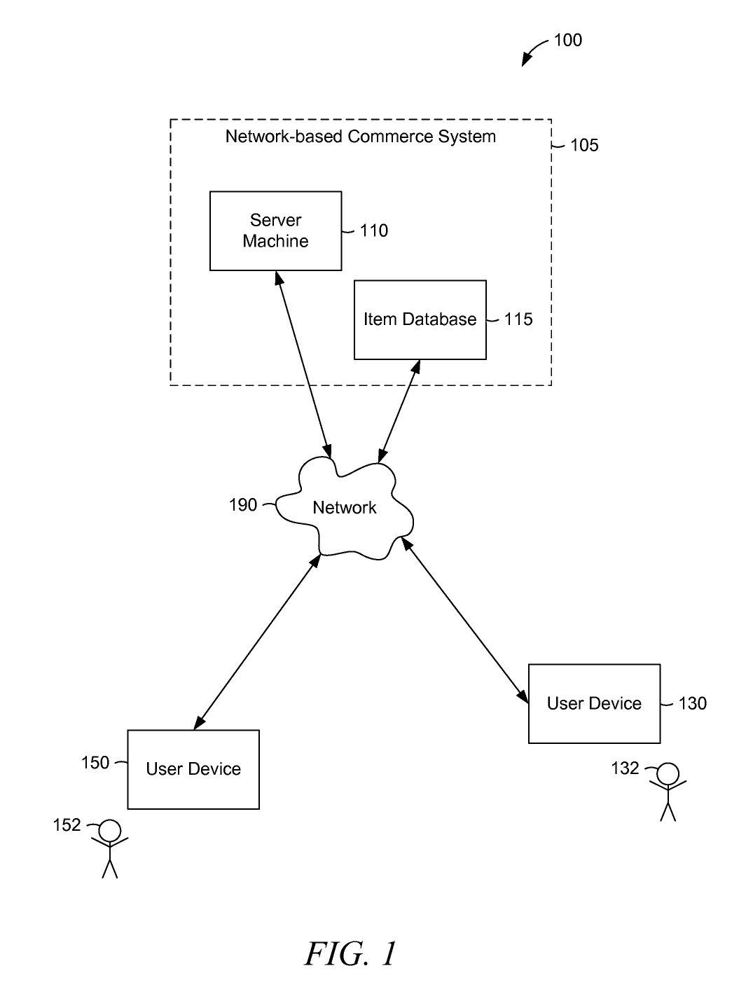

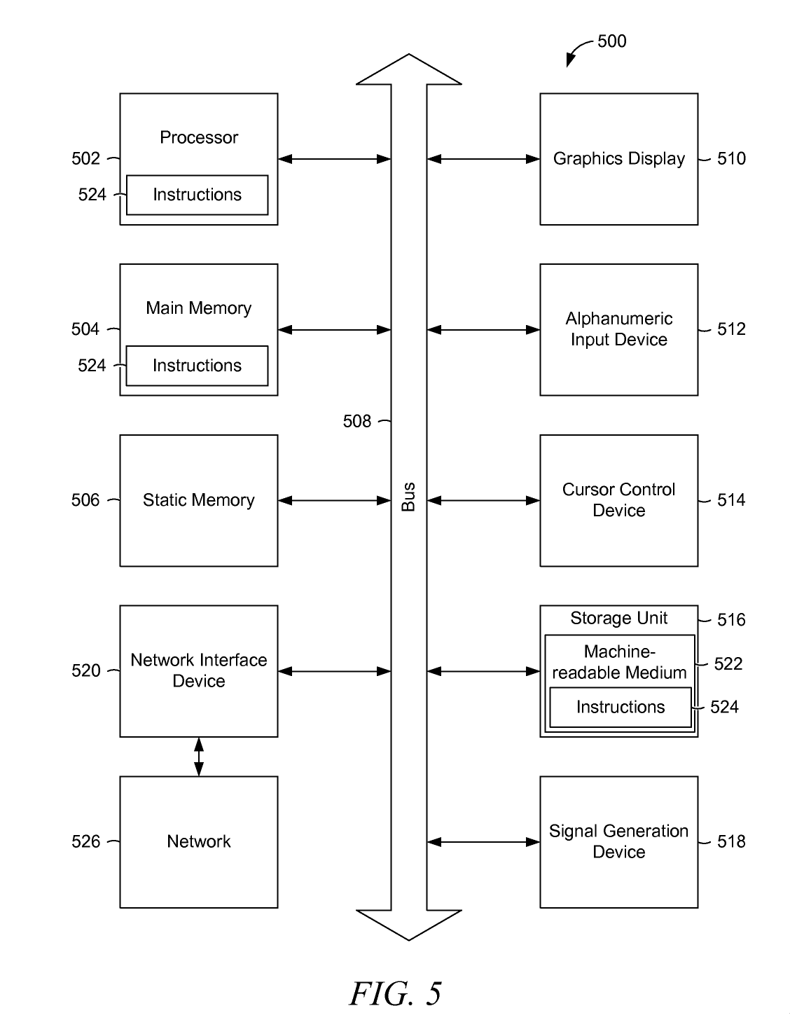

FIG. 1 is a network diagram illustrating a network environment 100 suitable for generating recommendations, according to some example embodiments. The network environment 100 includes a server machine 110, an item database 115, and devices 130 and 150, all communicatively coupled to each other via a network 190. The server machine 110, the item database 115, and the devices 130 and 150 may each be implemented in a computer system, in whole or in part, as described below with respect to FIG. 5. The server machine 110 and the item database 115 may be components of a network-based commerce system 105. The server machine 110 may be coupled to the network 190 while the item database 115 is coupled to the server machine 110 without being directly connected to the network 190, or both the item database 115 and the server machine 110 may be coupled to the network 190.

The server machine 110 may provide an electronic commerce application to other machines (e.g., the user device 130 or the user device 150) via the network 190. The electronic commerce application may provide a way for users to buy and sell items directly to each other, to a provider of the electronic commerce application, or both.

The item database 115 may provide data to other machines (e.g., the server machine 110, the user device 130, or the user device 150) via the network 190. The item database 115 may also receive data from other machines (e.g., the server machine 110, the user device 130, or the user device 150) via the network 190.

The item database 115 may store data about items (e.g., books, cars, guitars, and other tangible or intangible goods). For example, the database may have tables storing information regarding books, DVDs, and cars. These tables may indicate not only static information about the items such as title, length, and model year, but also dynamic information such as a current market value or topicality rating (e.g., a number of times the item has been flagged in Twitter hashtags over the past week, a number of times the item has been mentioned in blogs, news articles, or reviews over the past few days, or any suitable combination thereof).

The item database 115 may also store data about users. For example, a record for a user may include the date the user's record was created, a name of the user, an address of the user, a phone number of the user, an electronic communication address of the user, a date of birth of the user, an age of the user, a gender of the user, or an income bracket of the user.

The item database 115 may also have tables indicating which of these items is owned by a particular user. Records regarding items may indicate whether each item is new or used. Records regarding items owned by users may indicate the date on which the item was purchased by the user. The item database 115 may also store records reflecting past transactions of items. For example, a retailer may add records of new items for sale. A user may purchase one of the items on a first date, and sell the item on a second date. A record for the item may indicate the current owner, the last transaction date, the item condition, and the price paid, while other transaction records store the dates, parties, and prices paid in those transactions. Records of transactions may be created when the transaction occurs (for example, on the same date as the transaction). The condition of an item may be new or used, or include finer grades such as mint, near mint, very fine, fine, good, and poor. Records regarding items may also indicate an edition or version. For example, a book may have been printed in a first edition, a second edition, and a third edition. As another example, software may have been released in multiple versions such as a version 1.0, version 1.1, and version 2.0.

Also shown in FIG. 1 are users 132 and 152. One or both of the users 132 and 152 may be a human user (e.g., a human being), a machine user (e.g., a computer configured by a software program to interact with the user device 130), or any suitable combination thereof (e.g., a human assisted by a machine or a machine supervised by a human). The user 132 is not part of the network environment 100, but is associated with the user device 130 and may be a user of the user device 130. For example, the user device 130 may be a desktop computer, a vehicle computer, a tablet computer, a navigational device, a portable media device, or a smart phone belonging to the user 132. Likewise, the user 152 is not part of the network environment 100, but is associated with the user device 150. As an example, the user device 150 may be a desktop computer, a vehicle computer, a tablet computer, a navigational device, a portable media device, or a smart phone belonging to the user 152.

Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 5. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases, and devices (e.g., the server machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof.

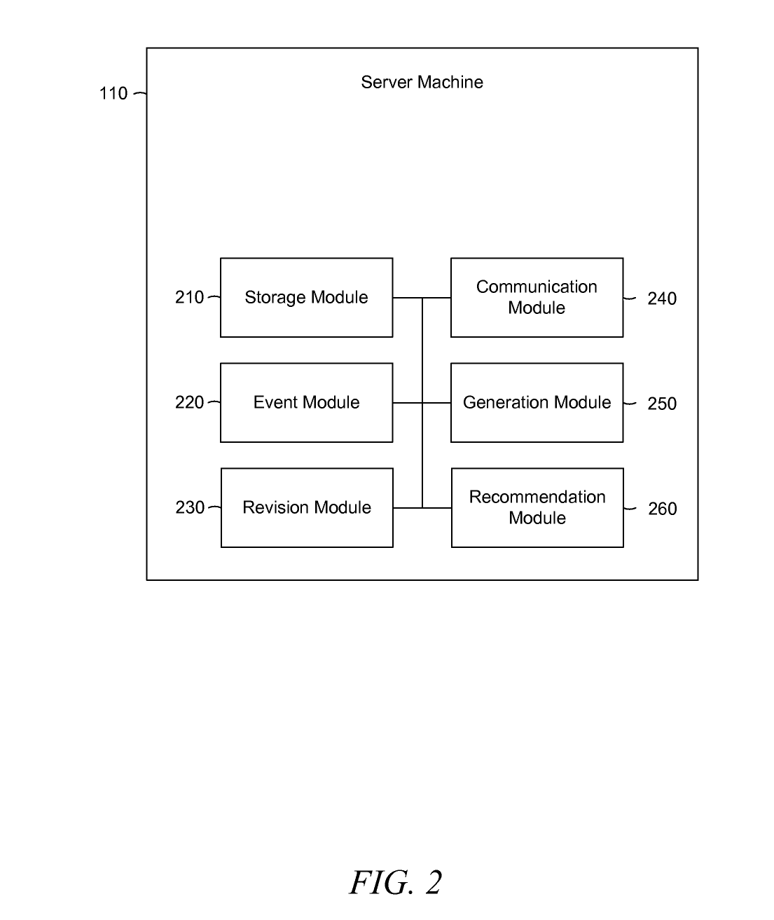

FIG. 2 is a block diagram illustrating components of the server machine 110, according to some example embodiments. The server machine 110 is shown as including a storage module 210, an event module 220, a revision module 230, a communication module 240, a generation module 250, and a recommendation module 260, all configured to communicate with each other (e.g., via a bus, shared memory, or a switch). Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The storage module 210 may be configured to exchange information with the item database 115. The storage module 210 may store information regarding items or users in the item database 115. Additionally, the storage module 210 may retrieve information regarding items or users in the item database 115. The storage module 210 may also process the information before or after storing or retrieving the information.

The event module 220 may be configured to gather information about events (e.g., events that have already occurred, are presently occurring, are expected to occur, or any suitable combination thereof). The event module 220 may store information about events in the item database 115, or retrieve information about events from the item database 115. In other example embodiments, the event module 220 uses a separate database (not shown) to store data about the event. The event may be a physical event (e.g., a concert, a war, a movie screening) or a publication event (e.g., an article about the concert, a blog post about the war, or a review based on the movie screening, or any suitable combination thereof). The information about an event may be static (e.g., a name of the event, a date of the event, an event's location, a cost of the event, or a size of the event) or dynamic (e.g., a current level of interest in the event or a probability of the event occurring), or both.

The revision module 230 may be configured to revise data regarding events, items, or users. For example, the revision module 230 may modify data stored in the item database 115 upon request by the user. In some example embodiments, the revision module 230 may detect that an item has been bought via an electronic commerce site by a user and modify the item database 115 to reflect the fact that the user now owns the item. In some example embodiments, the revision module 230 may detect that an item has been sold via an electronic commerce site by a user and modify the item database 115 to reflect the fact that the user no longer owns the item. In some embodiments, the revision module 230 may update the item database 115 without additional user involvement.

The communication module 240 may be configured to communicate with external users and systems. For example, the communication module 240 may use a web crawler to access a number of web pages. These web pages may be parsed to gather information regarding events. In some example embodiments, the gathered information is communicated to the event module 220 or the revision module 230. In another example, the communication module 240 communicates with users via a user interface (“UI”). The UI may present the user with, for example, a selector operable to indicate an item owned by the user. The information gathered from the user may be communicated to the storage module 210 or the item database 115.

The generation module 250 may be configured to place listings of items for sale in an electronic commerce site. The items listed may be items already owned by the user. The listing of the item by the generation module 250 may be triggered by the recognition of an event by the event module 220.

The recommendation module 260 may be configured to generate recommendations to users that they buy or sell items. In some example embodiments, the item database 115 is used in conjunction with an electronic commerce site. In such embodiments, the machine may be aware of which item in the site the user is viewing. Then, the recommendation made by the recommendation module 260 may take into account the item being viewed as well as the items owned. For example, if the user owns a motorcycle and is viewing a motorcycle accessory, such as a special headlamp, the recommendation module 260 may present recommendations for other motorcycle accessories. On the other hand, if the user owns many lighting-related items and is viewing a motorcycle headlamp, the recommendation module 260 may present recommendations for other headlamps instead. Of course, these recommendations can be based on any predictive correlation between the items owned by the user and the item being viewed, and is not limited to categorization. In some example embodiments, the recommendation is based on the user's item viewing history, not merely the item currently being viewed.

The user may be presented with an option to indicate that the user is receptive to offers on the item, but is not actively placing the item for sale. For example, the user may be happy to own a collectible item, but willing to sell it if another collector is willing to offer a high enough price. The user may then indicate that offers will be accepted. The user may also indicate a minimum offer that would be considered.

The recommendation module 260 may make recommendations based on the price of the item being viewed. For example, if the user is viewing an item costing $1000, and the user owns an item worth a comparable amount, the machine may suggest that one way to pay for the item being viewed would be to sell the owned item.

The recommendation module 260 may access information about the user's financial assets. In such example embodiments, the server machine 110 may present a total worth for the user, summing the current market value of the items owned by the user with the current market value of the user's financial assets. In some example embodiments, buy or sell recommendations are based on the user's financial assets as well as the set of items owned by a user. For example, a user that owns many comic books but has few financial assets may receive a recommendation to buy bargain comic books while a user that owns many comic books and has substantial financial assets may receive a recommendation to buy high-priced collectible comic books.

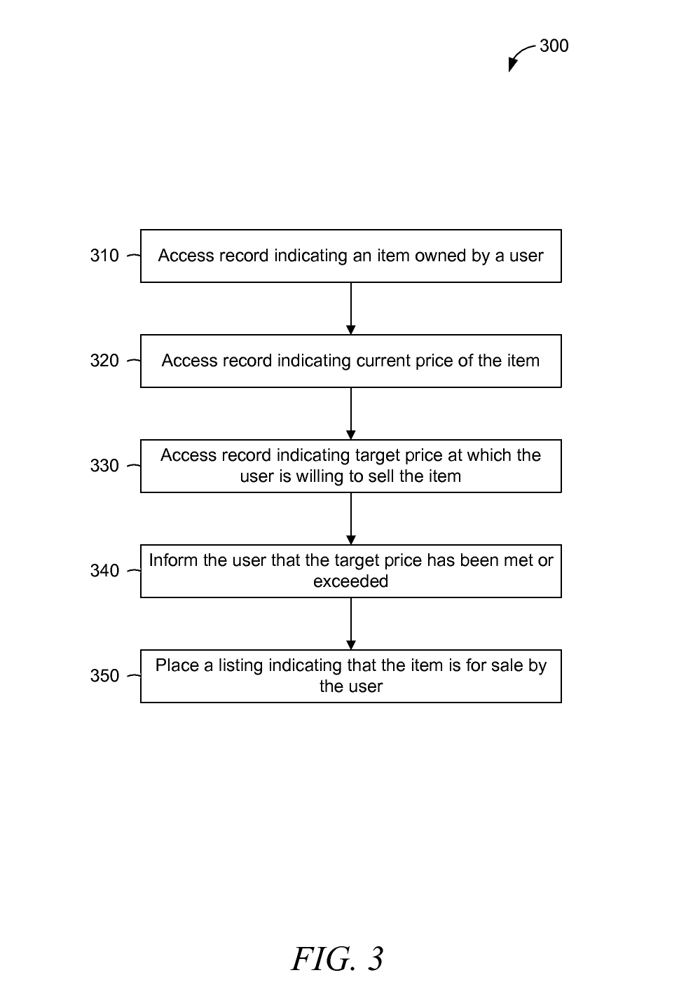

FIG. 3 is a flowchart illustrating operations of the server machine 110 in performing a method 300 of providing a selling recommendation, according to some example embodiments. The method 300 may be performed after a user has entered a target price at which the user is willing to sell an item. For example, a user may be presented with a user interface including descriptions of one or more items in the user's inventory. The user interface may be operable to cause target prices for one or more of the described items. Operations in the method 300 may be performed by the server machine 110, using modules described above with respect to FIG. 2, and accessing the target prices set by the user.

In operation 310, the recommendation module 260 accesses a record indicating an item owned by a user. In some example embodiments, the record may be accessed via the storage module 210 or directly from the item database 115.

In operation 320, the recommendation module 260 accesses a record indicating a current price of the item. In some embodiments, the current price is stored in the item database 115 as an attribute of the item. In other embodiments, the current price is calculated at the time of access from a set of price points. Each price point may reflect an individual price for the item or an amalgamation of prices (e.g., from a source, to a buyer, made on a date, or any suitable combination thereof). Each price point may reflect an offer to sell, an offer to buy, a completed transaction, or any suitable combination thereof.

In some example embodiments, the recommendation module 260 also determines an expected length of time between listing the item and selling the item. The recommendation module 260 may give a sell recommendation based on the expected length of time.

In operation 330, the recommendation module 260 accesses a record indicating a target price at which the user is willing to sell the item. The target price may be stored in the item database 115, and may have been previously set by the user via the communication module 240. In some embodiments, the recommendation module 260 compares the target price with the current price of the item.

In operation 340, the communication module 240 informs the user (e.g., by sending an email to the user, by sending a text message to the user, by sending a message via the electronic commerce site's messaging system, by presenting a pop-up window in a web browser, or any suitable combination thereof) that the target price has been met or exceeded by the current price of the item. In some embodiments, the communication module 240 receives a confirmation from the user indicating that the user desires to place the item for sale.

In operation 350, the generation module 250 generates a listing for the item in the electronic commerce site. In some example embodiments, the listing for the item is an auction listing. In some example embodiments, the listing for the item includes a set price for sale. The listing may include information about the item and user from the item database 115. In some example embodiments, the listing for the item is created by the generation module 250 without user intervention. In such embodiments, the user may be notified by the communication module 240 after or contemporaneously with the creation of the listing. In other embodiments, the listing for the item is created by the generation module 250 in response to the confirmation received from the user in the operation 340.

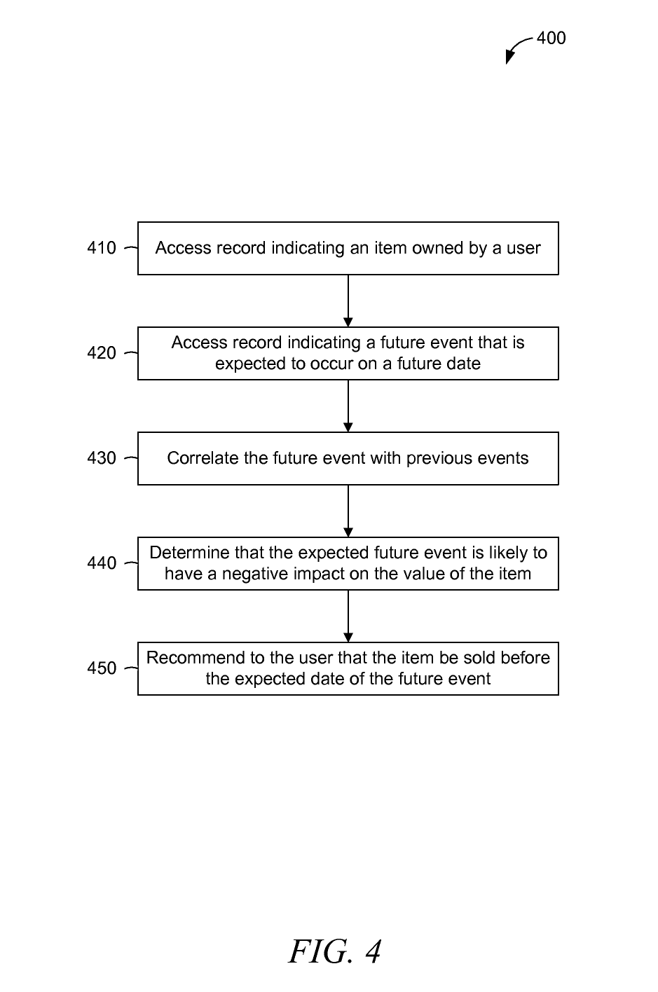

FIG. 4 is a flowchart illustrating operations of the server machine 110 in performing a method 400 of providing a selling recommendation, according to some example embodiments. Operations in the method 400 may be performed by the server machine 110, using modules described above with respect to FIG. 2.

In operation 410, the recommendation module 260 accesses a record indicating that an item is owned by a user. In some example embodiments, the record may be accessed via the storage module 210 or directly from the item database 115.

In operation 420, the recommendation module 260 accesses a record indicating that an event is expected to occur on a future date. In some example embodiments, the record is accessed from the event module 220. In some example embodiments, the event module 220 initiates the method 400 by notifying the recommendation module 260 when information about the event is stored.

In operation 430, the event module 220 correlates the future event with previous events. In some embodiments, the event module 220 performs the correlation via statistical analysis. In other embodiments, the event module 220 performs the correlation by retrieving results from a database. For example, an administrator may have pre-categorized various events and determined their correlations based on temporal proximity, spatial proximity, subject matter, and the like. In this example, the event module 220 may perform the correlation simply by looking up the value in a pre-computed table.

In operation 440, the event module 220 determines that the expected future event is likely to have a negative impact on the value of the item. In some example embodiments, the determination is made based on the correlation of the event with past events. A replacement item for a first item is an item that may be used in place of the first item. For example, a new version of a software title may be a replacement for an old version of the title. As another example of a replacement item, one brand of tablet computer may be a replacement for another brand of tablet computer. As an example of a future event having a negative impact on the value of an item, if the event indicates that a new version of a popular software title will be released soon, and past events indicate that the value of older copies of the software drops when new versions are released, a determination can be made that the value of the user's copy of the older software will drop. In other example embodiments, the determination is made based on the event itself. For example, if the event is a news report indicating that air conditioners using Freon will be outlawed at the beginning of the next year, the determination that such an item owned by the user will drop in value does not necessarily rely on correlation of the event with past events.

In operation 450, the communication module 240 recommends to the user that the item be sold before the expected date of the future event. As discussed above with respect to operation 340, the communication module 240 may use a variety of means to communicate this information to the user. In some example embodiments, the communication module 240 also presents an option to the user to place the item for sale or to accept the recommendation. For example, the communication may include a hyperlink that, when activated, places a listing of the item for sale in the electronic commerce site.

According to various example embodiments, one or more of the methodologies described herein may facilitate the managing of user inventories and the generation of recommendations based on those inventories. Moreover, one or more of the methodologies described herein may facilitate the generation of recommendations that are available to a particular device or a user thereof. Hence, one or more the methodologies described herein may facilitate retrieval and presentation of information regarding the user's inventory, as well as enhanced recommendation capabilities by the device without access to the server or the electronic commerce site.

When these effects are considered in aggregate, one or more of the methodologies described herein may obviate a need for certain efforts or resources that otherwise would be involved in determining when to sell an item or what items are of interest. Efforts expended by a user in identifying items of interest may be reduced by one or more of the methodologies described herein. Computing resources used by one or more machines, databases, or devices (e.g., within the network environment 100) may similarly be reduced. Examples of such computing resources include processor cycles, network traffic, memory usage, data storage capacity, power consumption, and cooling capacity.

FIG. 5 is a block diagram illustrating components of a machine 500, according to some example embodiments, able to read instructions from a machine-readable medium (e.g., a machine-readable storage medium, a computer-readable storage medium, or any suitable combination thereof) and perform any one or more of the methodologies discussed herein, in whole or in part. Specifically, FIG. 5 shows a diagrammatic representation of the machine 500 in the example form of a computer system and within which instructions 524 (e.g., software, a program, an application, an applet, an app, or other executable code) for causing the machine 500 to perform any one or more of the methodologies discussed herein may be executed, in whole or in part. In alternative embodiments, the machine 500 operates as a standalone device or may be connected (e.g., networked) to other machines. In a networked deployment, the machine 500 may operate in the capacity of a server machine or a client machine in a server-client network environment, or as a peer machine in a distributed (e.g., peer-to-peer) network environment. The machine 500 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 524, sequentially or otherwise, that specify actions to be taken by that machine. Further, while only a single machine is illustrated, the term “machine” shall also be taken to include a collection of machines that individually or jointly execute the instructions 524 to perform all or part of any one or more of the methodologies discussed herein.

The machine 500 includes a processor 502 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 504, and a static memory 506, which are configured to communicate with each other via a bus 908. The machine 500 may further include a graphics display 510 (e.g., a plasma display panel (PDP), a light emitting diode (LED) display, a liquid crystal display (LCD), a projector, or a cathode ray tube (CRT)). The machine 500 may also include an alphanumeric input device 512 (e.g., a keyboard), a cursor control device 514 (e.g., a mouse, a touchpad, a trackball, a joystick, a motion sensor, or other pointing instrument), a storage unit 516, a signal generation device 518 (e.g., a speaker), and a network interface device 520.

The storage unit 516 includes a machine-readable medium 522 on which is stored the instructions 524 embodying any one or more of the methodologies or functions described herein. The instructions 524 may also reside, completely or at least partially, within the main memory 504, within the processor 502 (e.g., within the processor's cache memory), or both, during execution thereof by the machine 500. Accordingly, the main memory 504 and the processor 502 may be considered as machine-readable media. The instructions 524 may be transmitted or received over a network 526 (e.g., network 190) via the network interface device 520.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 522 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions for execution by a machine (e.g., machine 500), such that the instructions, when executed by one or more processors of the machine (e.g., processor 502), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

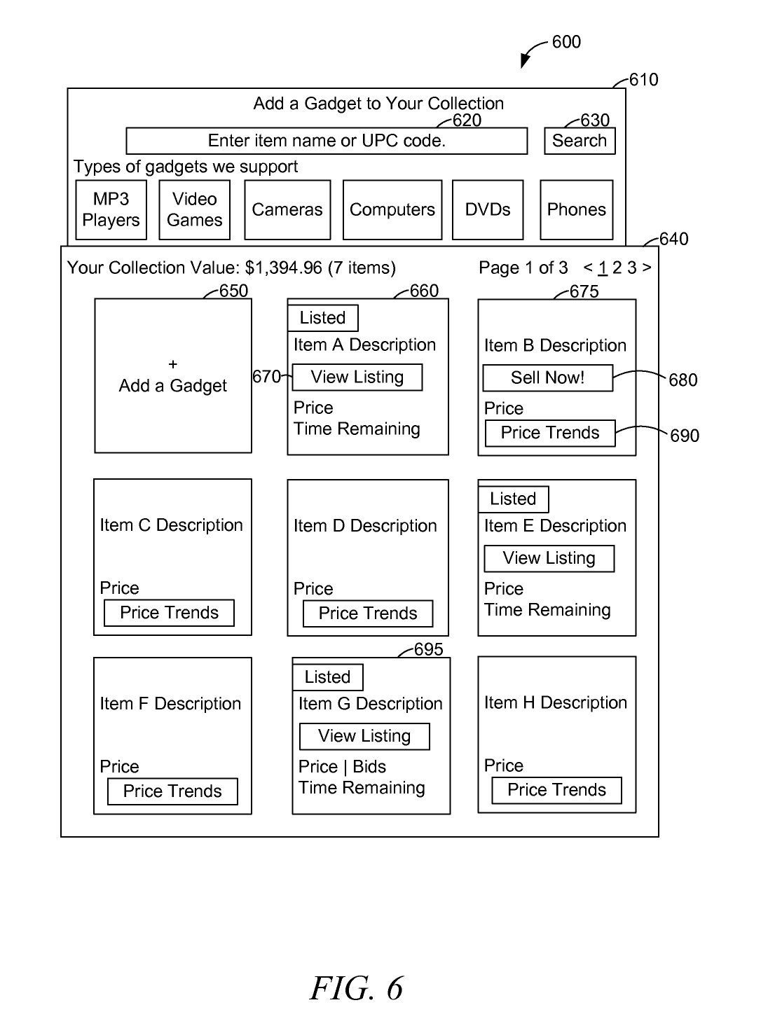

FIG. 6 is a user interface diagram 600 presenting a user interface with information regarding the items owned by the user. An element 610 includes a text field 620 to the user in which the user may enter a name, a universal product code (“UPC”), or other type of identifier for an item. A button 630 may trigger a search for items matching the name or UPC code entered in the text field 620. In this example, the items are referred to as “Gadgets.” Also shown is a set of types of items supported. In this case, the types are “MP3 Players,” “Video Games,” “Cameras,” “Computers,” “DVDs,” and “Phones.” A focus on small electronic devices (e.g., gadgets) may be advantageous because such items tend to be relatively affordable to ship (as compared to, for example, furniture) and have relatively high value (as compared to, for example, books or food).

An area 640 shows a total value of the user's inventory as $1,394.96 and as consisting of seven items. The area 640 also shows that three pages of listings are available, and that currently the first page is being viewed. An element 650 may be operable to add an item to the user's inventory. For example, clicking on the element 650 may cause a user interface element such as that shown in element 610 to be presented.

An element 660 shows information regarding an item from the user's inventory listed for sale in a fixed-price format. The presented information regarding the item includes a description (e.g., an image, a text description, or both), an indicator that the item is currently listed for sale, a price of the item, and time remaining in a listing of the item for sale. An element 670 may be operable to display the listing of the item.

An element 675 shows information regarding an item from the user's inventory that is not listed for sale. The presented information regarding the item includes a description and a price of the item. The price of the item may be an estimated value of the item. An element 680 may be operable to create a listing for the item, while an element 690 may be operable to cause display of price trend data for the item.

The element 680 may be presented based on a determination to recommend the sale of the item 675 to the user. For example, many users may be searching for Item B while few users are currently selling Item B. Based on the high level of demand for Item B and the user's ownership of Item B, a recommendation to sell the item 675 may be presented to the user.

An element 695 shows information regarding an item from the user's inventory for sale in an auction format. The presented information regarding the item includes a description, an indicator that the item is currently listed for sale, a current price of the item, a number of bids placed on the item, and time remaining in the auction of the item. The button labeled “View Listing” may be operable to display the listing of the item.

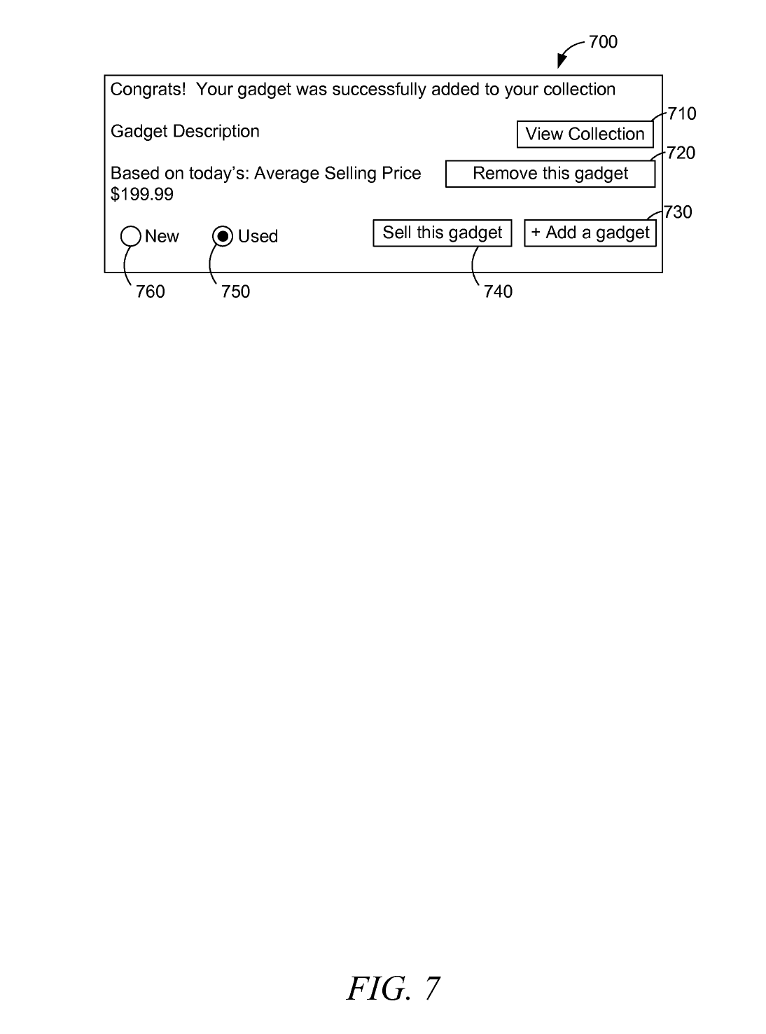

FIG. 7 shows a UI 700 that may be displayed after a user has added a gadget to their inventory. The UI 700 shows a value of the item as $199.99. In some embodiments, the UI 700 shows a total value of the user's inventory. A button 710 may be operable to view the user's inventory. A button 720 may be operable to delete a displayed item from the user's inventory. A button 730 may be operable to add an item to the user's inventory, while a button 740, labeled “Sell this gadget,” may be operable to generate a listing of the displayed item for sale. Radio buttons 750 and 760 may be operable to set and display status of the item as new or used.

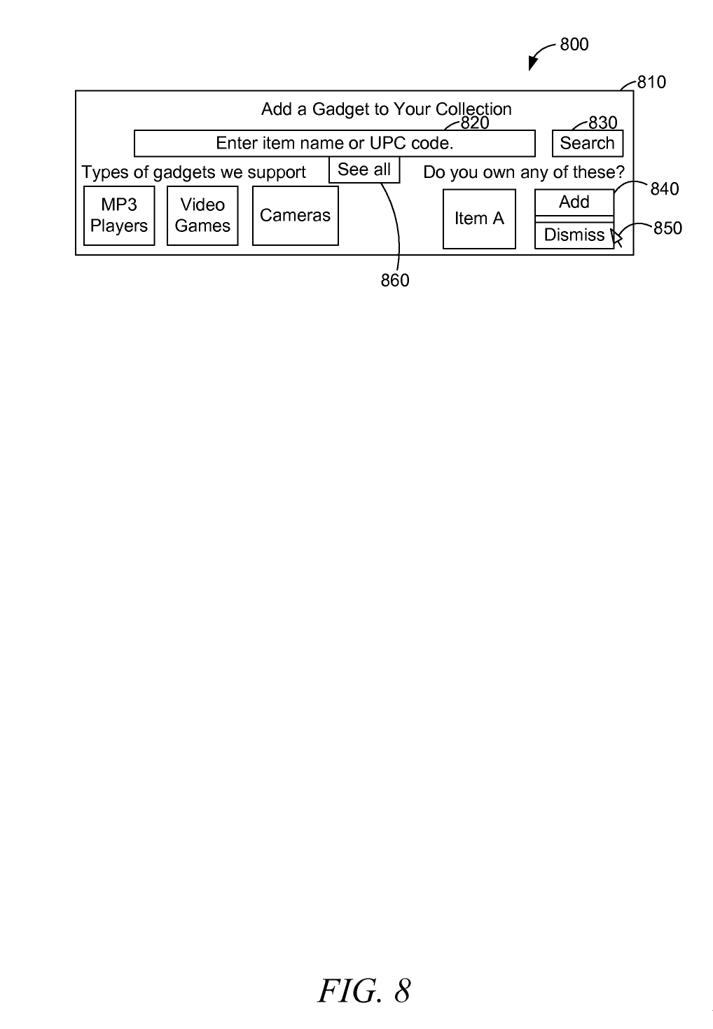

FIG. 8 shows a UI 800 that prompts a user to add specific items identified by the server machine 110 as being likely to be owned by the user. In this case, the system is asking “Do you own any of these?” regarding “Item A” and another item hidden behind buttons 840 and 850. The system may determine items to present to a user by comparing items owned by the user with items owned by other users to determine a probability that an item is owned without being part of the user's inventory. Here, the user is presented with a button 840 labeled “Add” and a button 850 labeled “Dismiss” for the second item, hidden behind the buttons 840 and 850. By selecting the button 840, the user can add the item to the inventory without typing in the item name or UPC. By selecting button 850, the user can avoid receiving the same prompt in the future. The buttons 840 and 850 may be hidden until the user hovers their cursor over the item (e.g., Item A). The server machine 110 may keep track in the item database 115 which items have been presented to the user and dismissed, for example, using the event module 220.

The types of gadgets supported are shown as MP3 players, Video Games, and Cameras. A button 860 may be operable to see additional types of gadgets supported by the server machine 110.

In some embodiments, the system may automatically detect that items are owned by the user. For example, the system may prompt the user for permission to access the user's recent PayPal transactions. Upon receiving permission, the system may review the transactions to determine which items were purchased by the user. Such items may be added to the user's inventory. In another example embodiment, the system may prompt the user for permission to access the user's email account. Upon receiving permission, the system may review the user's email to find purchase receipts from online retailers. Any item identified in such a review may be added to the user's inventory.

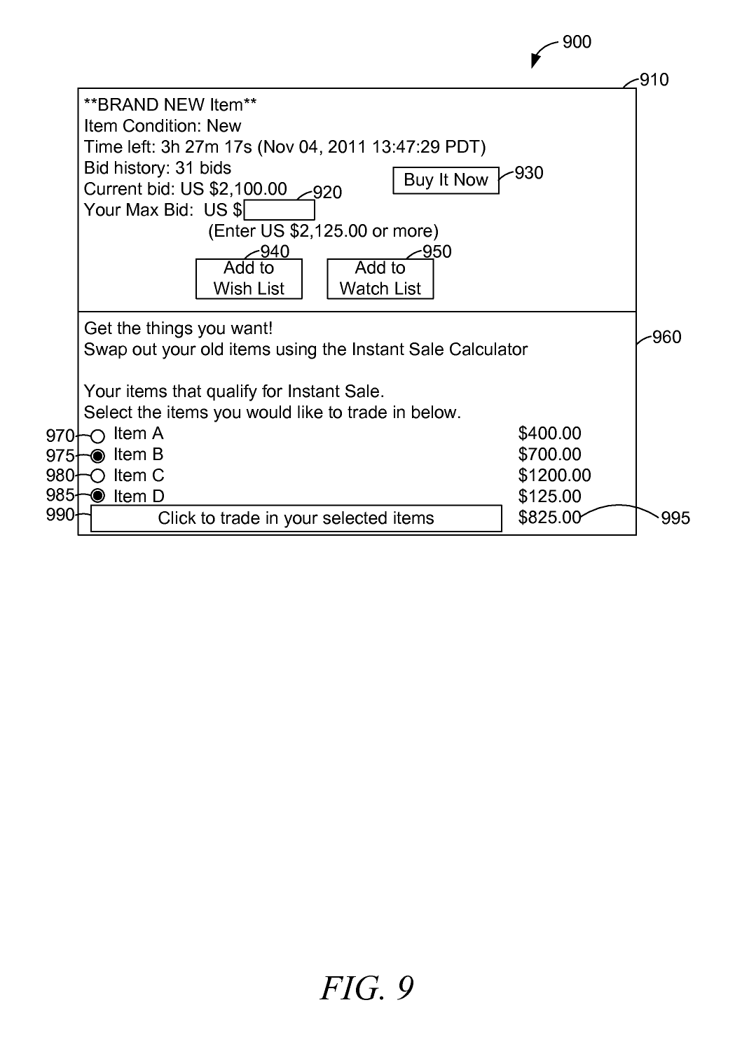

FIG. 9 shows a UI 900 including area 910 containing information regarding a listing of an item for sale. The current price of the item is $2100. The user may interact with the listing of the item by entering a bid in a field 920 or operating a button 930 to execute a fixed price or buy-it-now transaction.

A button 940 may be operable to add the item or the listing for the item to a wish list of the user. A wish list may be a list of items or listings available for others to see (e.g., as gift suggestions). Another button 950 may be operable to add the listing for the item to a watch list of the user. A watch list may be a list of listings the user is interested in tracking. For example, the system may send email updates to the user containing information regarding listings on the user's watch list.

An area 960 may contain a list of recommendations to the user of items to sell. The list may be provided as a suggestion to sell one or more items in order to purchase the item for sale shown in area 910. The recommendations may be based on the inventory of items known to be owned by the user, the price of the items in the inventory, and the price of the item for sale. In this example, the user is invited to sell four items ranging in value from “Item D” at $125 to “Item C” at $1200. Radio buttons 970-985 may be operable to select items to sell. As indicated by the radio buttons 970-985, the user has selected two items to sell, “Item B” and “Item D.” The system has totaled the value of the items at $825.00, as shown by text element 995, and is prompting the user to confirm the intent to sell the items with a button 990. As shown in the UI 900, the sale of the listed items to generate money to be used toward the purchase of the listed item is referred to as a “trade in.”

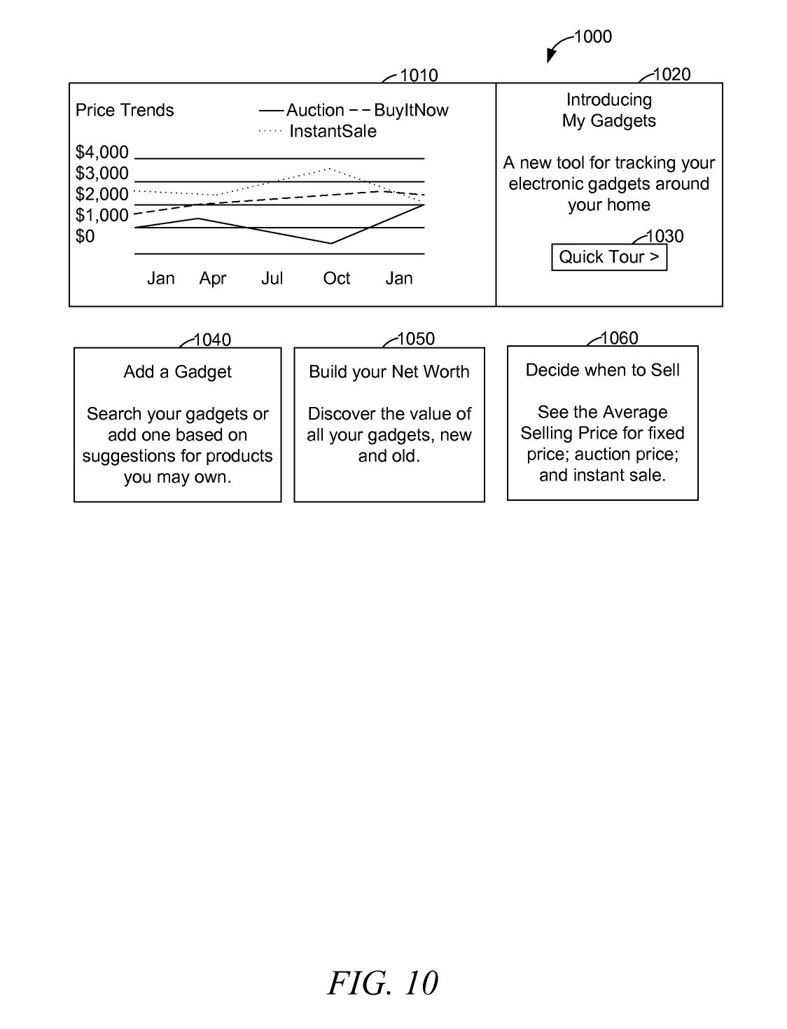

FIG. 10 shows a UI 1000 including areas 1010, 1020, 1040, 1050, and 1060. The area 1010 shows an example price trend graph indicating a fluctuating value of an inventory over time. The price trend graph in the area 1010 shows three different value lines, representing three different methods of liquidating the inventory: auction, fixed-priced sale, and instant sale. An instant sale is a sale at a price pre-set by the buyer. For example, the online marketplace can set the price at which it is willing to buy an item or users may identify items and specify prices they are willing to pay.

The area 1020 indicates that it is introducing a “My Gadgets” tool capable of tracking a user's inventory, showing the value of each item, and helping the user determine when to sell each item. A button 1030, labeled “Quick Tour,” may be operable to cause the presentation of additional information regarding the tool. The areas 1040-1060 may present additional information regarding the tool.

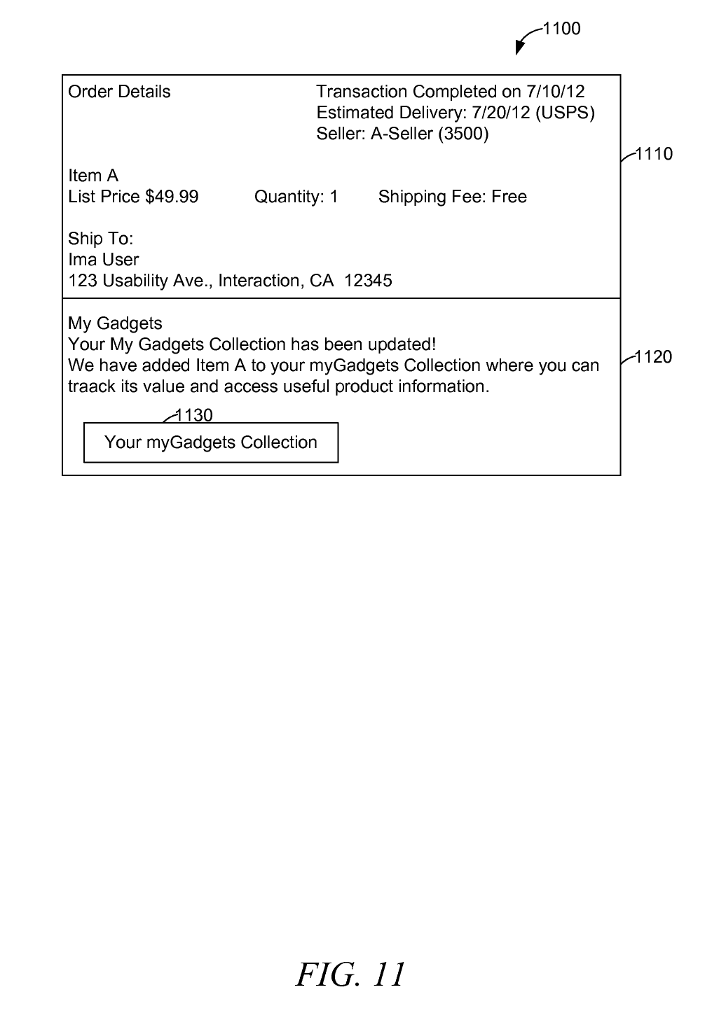

FIG. 11 shows a UI 1100 including areas 1110 and 1120. The area 1110 shows that the user has purchased “Item A” and includes details regarding the item and the transaction. The area 1120 indicates that the system has added the item to the user's “myGadgets Collection” so the user can track its value and access product information. The user is also presented with a button 1130 labeled “Your myGadgets Collection” which may be operable to access the user's inventory.

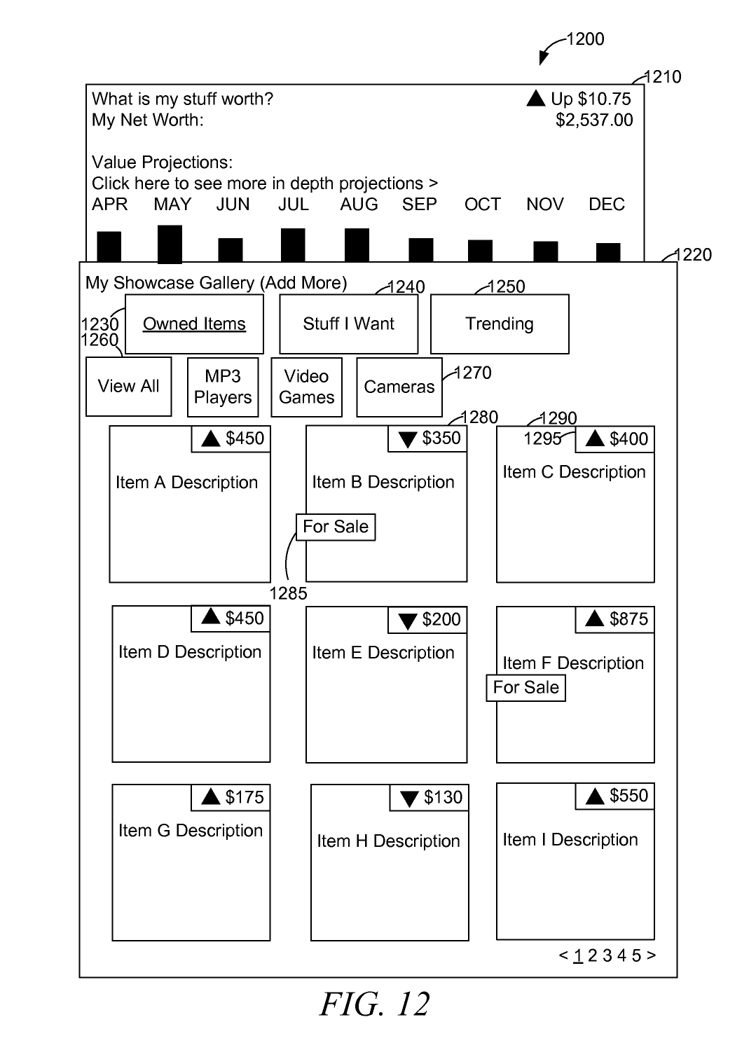

FIG. 12 shows the UI 1200 including areas 1210 and 1220. The area 1220 shows a portion of a user's inventory. In the lower-right corner of the area 1220, numbers 1-5 appear, providing an mechanism by which the user can flip to different pages of the inventory. Buttons 1260 and 1270 may be operable to change the categories of items displayed in the area 1220. For example, the button 1260 may be operable to view all of the user's items while the button 1270 may be operable to filter the item display to show only cameras. The area 1220 includes descriptions of nine of the user's items. The descriptions may include images and text. Each description is contained in an area (e.g., area 1290 describing “Item C”). In the upper-right corner of the area 1290 is a price change indicator 1295 showing how much the price of the item has changed in value over a period of time (e.g., the past week). The price change indicator 1295 includes an upward-pointing arrow, which may indicate that the price has risen. By contrast, a price change indicator 1280 includes a downward-pointing arrow, which may indicate that the price of the corresponding item, “Item B,” has fallen. The price change indicator may be color-coded. For example, the items that have increased in value may show the change in green, while the items that have decreased show the change in red. An indicator 1285 labeled “For Sale” indicates that the user has placed the corresponding item (e.g., “Item B” and “Item F”) for sale.

Three tabs 1230, 1240, and 1250 are shown. The currently selected tab 1230 is labeled “Owned Items.” The currently selected tab 1230 may be indicated by underlining the label, highlighting the label, changing the color of the tab, changing the size of the tab, appending an arrow to the bottom of the tab, or otherwise visually distinguishing the currently selected tab from non-selected tabs. The other two tabs 1240 and 1250 are labeled “Stuff I Want” and “Trending,” respectively. The tab 1240 may be operable to display a set of items the user has indicated as wanting to own, such as a wish list. The database structure for tracking a user's wanted inventory may be similar to the structure for tracking a user's owned inventory. The recommendation system that suggests items a user wants to purchase may use information about items in the user's wanted inventory to make such recommendations. The tab 1250 may be operable to display items that are popular in the network-based commerce system 110 or on the Internet (for example, with popularity aggregated among multiple network-based commerce systems).

In the area 1210, the user's net worth is shown as $2537. This net worth is a sum of the values of the items in the user's inventory. A chart is also shown indicating how the net worth has changed in the past and is expected to change in the future. For example, some items depreciate in value as they get older. The system may have a general price trend for this depreciation, or a specific price trend based on the category of the item or the specific item itself. By applying this price trend either on the inventory as a whole or on an item-by-item basis, the future value of the user's inventory can be calculated. Some items may rise in value over time, and such a rising price trend may also be applied.

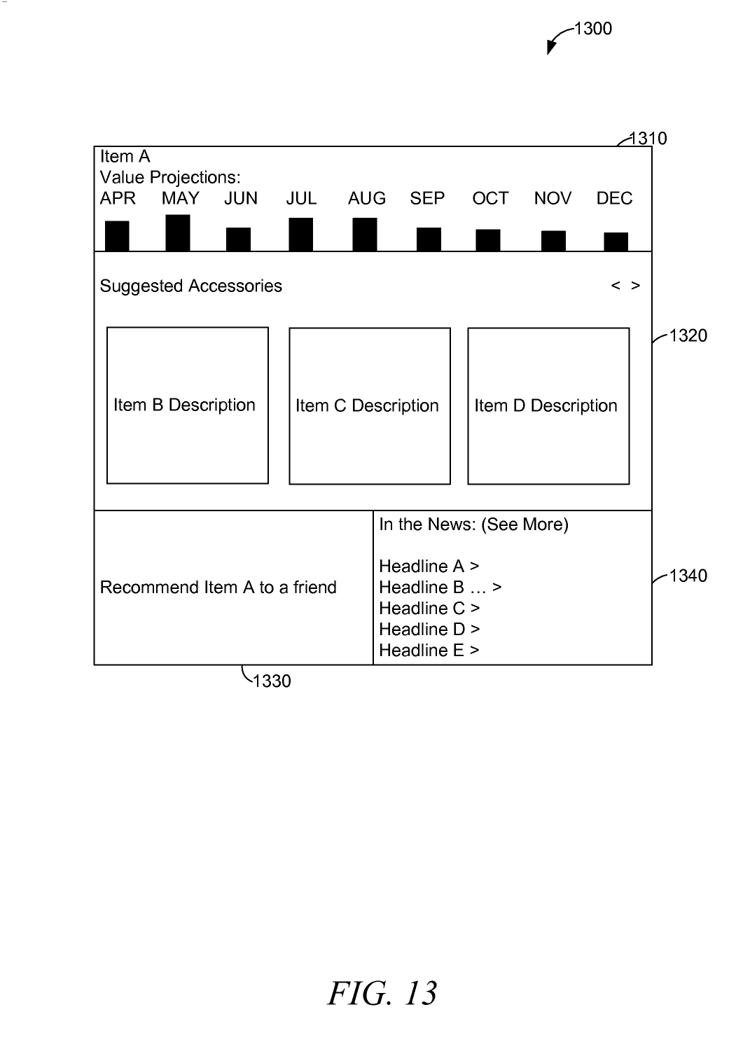

FIG. 13 shows a UI 1300 including areas 1310-1340. The area 1310 shows information regarding an “Item A” from a user's inventory. The information regarding “Item A” includes a value projections chart. The value projections chart may show the past, present, and projected future value of the item with respect to time.

The area 1320 shows descriptions of three suggested accessories. These items are recommended to the user based on the item being viewed, other items in the user's inventory, or both.

The area 1330 may be operable to recommend the item shown in the area 1310 to another user. For example, the item may be recommended to a friend of the user connected via a social network.

The area 1340 shows an “In The News” section, which includes the headlines for five articles referencing the viewed item. By clicking on one of the headlines, the user may view the article and learn more about the item or events that may impact the value of the item.

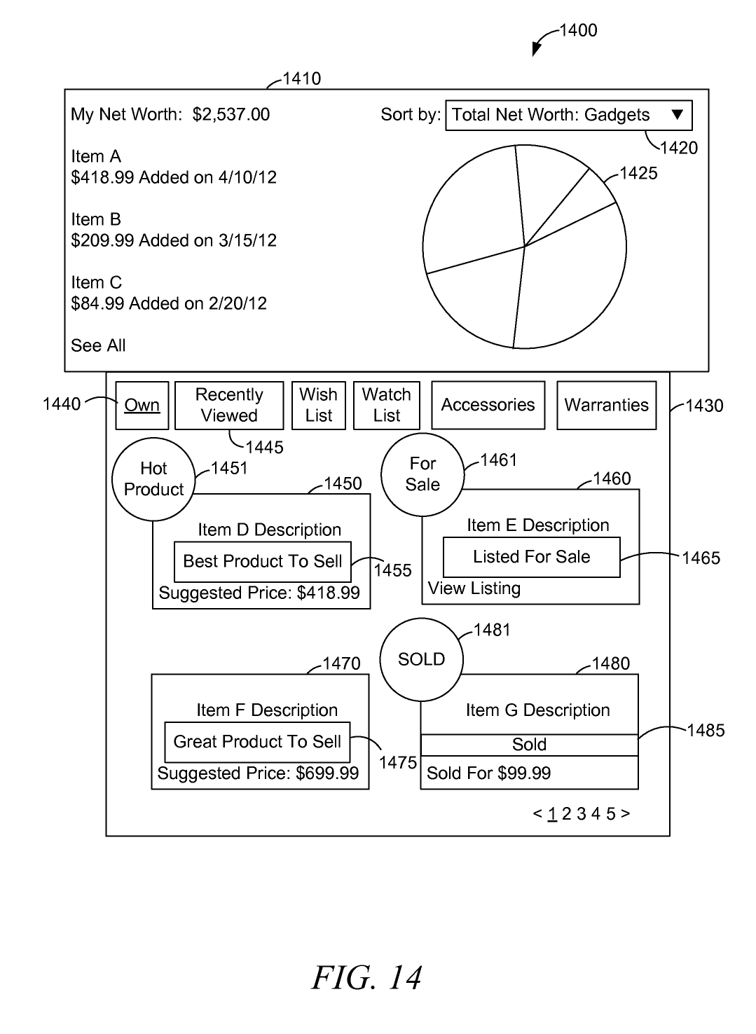

FIG. 14 shows a UI 1400 including areas 1410 and 1430. The area 1430 includes information about four items owned by the user in sub-areas 1450, 1460, 1470, and 1480.

The area 1410 contains aggregate information about the user's inventory. An element 1420 may be operable to change the information shown in the area 1410. For example, the element 1420 may be a drop-down menu with options to display information regarding a certain category of items in the user's inventory or information regarding all items in the user's inventory, and to sort the information in different ways. To illustrate, the element 1420 indicates that it is currently sorting by “Total Net Worth: Gadgets.” Accordingly, the selected items, “Item A,” “Item B,” and “Item C” may be items in the category of gadgets, and may be shown in decreasing order of value. Other example sorts include date added to the user's inventory and popularity on the online marketplace. The element 1425 is a pie chart that may indicate relative contributions of different items to the user's net worth. For example, individual slices of the pie may correspond to individual items or each slice may correspond to a category of items. The categories or items may be color-coded. In an embodiment, items may belong to multiple categories. Depicted items that have been sold may be listed with the price they were sold for, while depicted items that are currently for sale may be listed with their current prices. Additionally, depicted items that have not been sold may be listed with their current computed values (e.g., based on other sales).

The area 1430 contains detail information about the items in the user's inventory. Tabs 1440 and 1445 may be used to change the items shown. Tab 1440 is currently selected, and corresponds to the items owned by the user. Other tabs are operable to show items recently viewed by the user (e.g., items available for purchase by the user), items on the user's wish list (e.g., items the user has expressed interest in receiving from others), items on the user's watch list (e.g., items or listings the user has expressed interest in), items that are accessories to items the user owns (e.g., recommendations generated by the system for complementary items), and items that are warranties for items the user owns.

The sub-area 1450 contains information regarding “Item D.” The information may include an image, a description, a price, and so on. A marker 1451 indicates that the “Item D” is a “Hot Product.” The determination that an item is “hot” may be based on sales for the item, a number of times the item is added to wish lists or watch lists, or responsive to advertising revenue. A marker 1455 indicates that the system has recommended the sale of “Item D.” The recommendation of the sale of “Item D” may be based on the determination that it is a “Hot Product.” The sub-area 1450 for an item may also indicate a recommended action or price for the item. For example, the “Item D” that is recommended for sale has a “Suggested Price” of $418.99.

The sub-area 1460 contains information regarding “Item E.” Markers 1461 and 1465 indicate that the item of the sub-area 1460 is already listed for sale. The sub-area 1460 may include the amount of time remaining in the auction or fixed-price sale.

The sub-area 1470 contains information regarding “Item F.” A marker 1475 indicates that “Item F” is a recommended item to sell. The recommendation of the sale of “Item F” may be based on the suggested price for the item. For example, if the item is more valuable than other items in the user's inventory, selling it may generate funds more efficiently than the sale of less valuable items.

The sub-area 1480 contains information regarding “Item G.” Markers 1481 and 1485 indicate that the corresponding item, “Item G,” has been sold. The sub-area 1480 includes the price at which the item was sold.

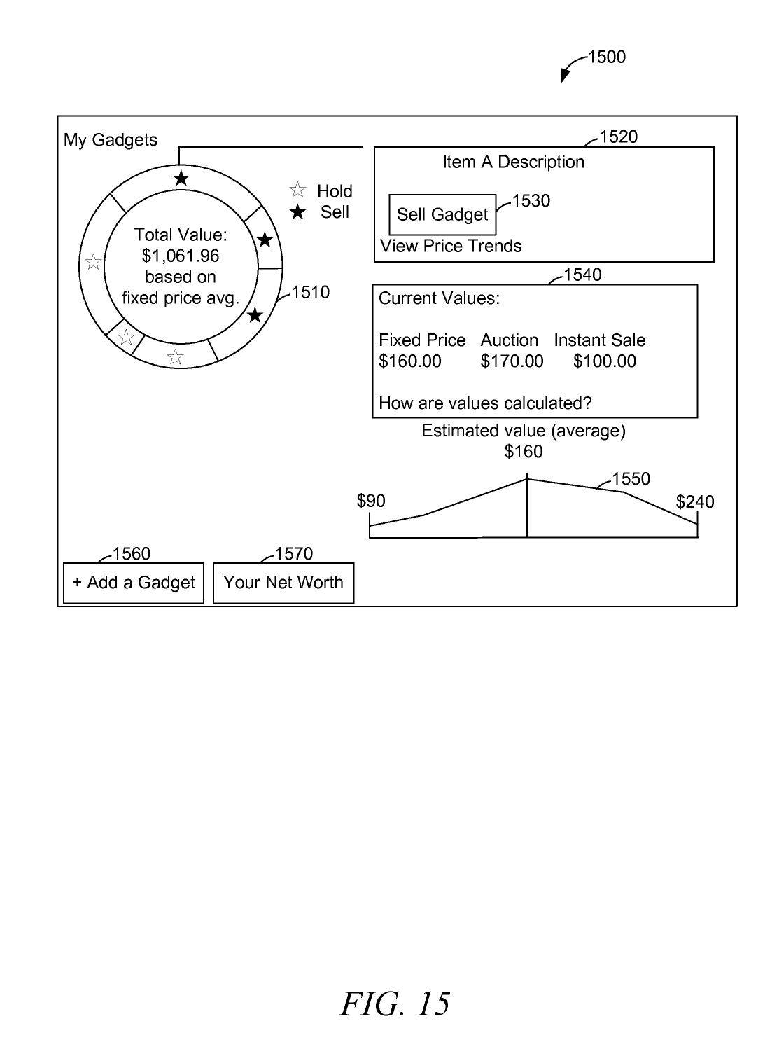

FIG. 15 shows a UI 1500 with aggregate information regarding the user's inventory and detail information regarding an item in the inventory. A center of a circle chart 1510 shows the user's net worth as $1061.96. The circle chart 1510 indicates that three owned items are for sale while another three items are not. Ownership status may be indicated graphically by, for example, filled/unfilled sections of the circle or color-coded sections of the circle. Relative areas of the circle chart 1510 indicate that the for-sale items make up more than half of the total value of the user's inventory. In areas 1520 and 1540, information regarding “Item A” is shown. A button 1530, within the area 1520, labeled “Sell Gadget,” may be operable to create a listing for the item. The area 1540 informs the user of three different current values for the item, indicating that the user can sell the item (e.g., to a dealer or the electronic commerce site itself) instantly for $100, or is likely to be able to sell the item at a fixed price of $160 or at auction for a winning bid of $170. A chart 1550 indicates a price distribution for “Item A” known by the system. For example, each “Item A” for sale may be included in the chart 1550 as a price point, with the vertical axis indicating the number of items for sale at each point. In this embodiment, the estimated value of the item is the average value of the price points, $160. The price distribution may be smoothed. For example, if one item is available at $90 and three items are available at $160, a line may be drawn from $90 at a height indicating one item to $160 at a height indicating three items. The smoothing may be done at different levels of granularity. In this example, a line may be drawn from one item at $90 to no items at $100, then from no items at $150 to three items at $160.

A button 1560 may be operable to add an item to the user's inventory. A button 1570 may be operable to show more information regarding the user's existing inventory.

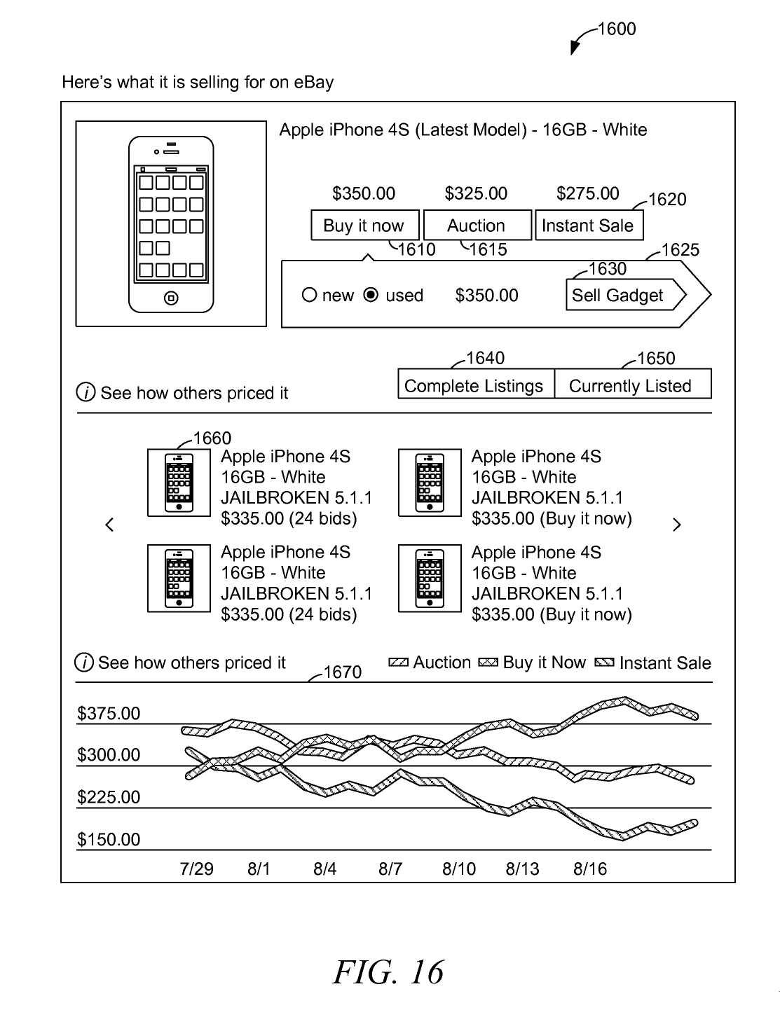

FIG. 16 shows a UI 1600 including information regarding an item labeled “Apple iPhone 4S (Latest Model)—16 GB—White.” Three values for the item are shown, with each price corresponding to one of three ways to sell the item. Buttons 1610-1620 may be operable to modify an area 1625 to show information corresponding to a way of selling the item corresponding to the activated button. For example, the user may click on the button 1615, labeled “Auction.” In response, the area 1625 may replace the displayed price of $350.00, corresponding to the currently-selected option of “Buy-It-Now,” with $325.00, an estimated auction price for the item. Similarly, the button 1620 may be operable to update the area 1625 with information regarding an “Instant Sale.”

The area 1625 may display additional information about the item, accept additional information about the item from the user, and include a button 1630 operable to create a listing for the item. For example, the area 1625 may contain radio buttons operable to indicate a new/used status of the item or checkboxes to indicate a presence or absence of optional features of the item.

The user may be shown existing listings for the item (e.g., the listing 1660), including the price at which it is being offered. Buttons 1640 and 1650 may be operable to select which listings are shown. For example, the button 1640 may be operable to cause display of listings that have already completed, while the button 1650 may be operable to cause display of pending listings.

A chart 1670 labeled “Price Trends” indicates the value of the item over time for each of three different sales methods: “Auction,” “Buy it Now,” and “Instant Sale.” The chart may be presented with UI controls operable to zoom in and out, to scroll forward and backward in time, or to display individual transactions. For example, a point on a line may be selected and the listing for the past transaction closest in time and price to the selected point may be displayed.

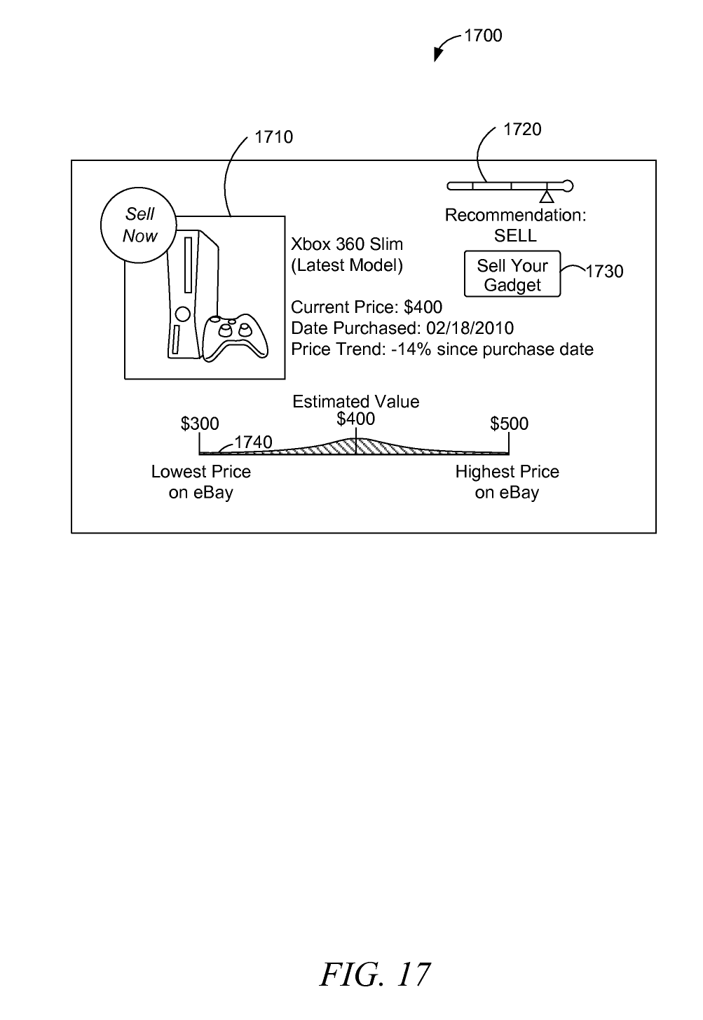

FIG. 17 shows a UI 1700 with a recommendation that the user sell an item depicted in image 1710, labeled “Xbox 360 Slim Black (Latest Model),” with a current price of $400. The UI 1700 also indicates a date the item was originally purchased, change in value of the item since the date of purchase, and distribution of prices (via a graph 1740) on the electronic commerce site. Also provided is a thermometer-shaped indicator 1720 that shows the strength of the recommendation. The indicator 1720 may be color coded. For example, the right-hand side of the indicator may be green, the left-hand side may be red, and the color may smoothly transition along the indicator 1720. Button 1730, labeled “Sell Your Gadget,” may be operable to allow the user to create a listing for the item shown in the image 1710.

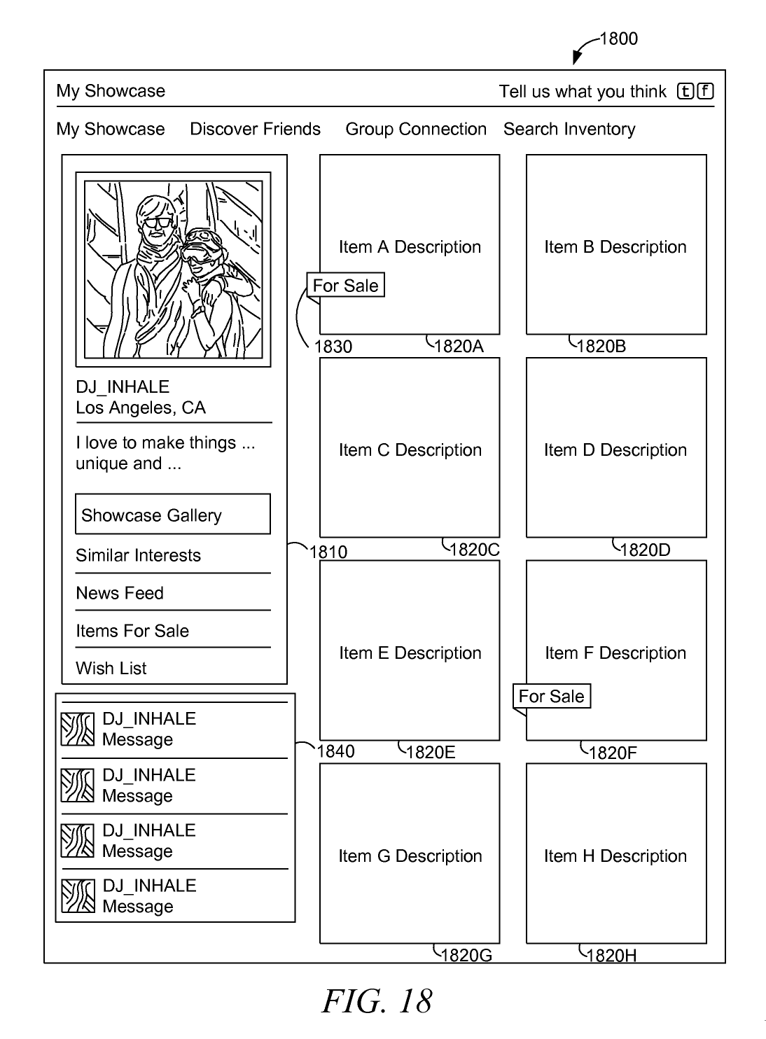

FIG. 18 shows a UI 1800 that is a showcase. More particularly, the UI 1800 shows a “Showcase” for the user “DJ_INHALE.” An area 1810 displays information regarding the user and may contain UI elements operable to cause the display of different sets of information regarding the user. For example, a user's showcase gallery may be selected and displayed, interests related to the user's interests may be selected and displayed, a news feed of news items related to the user's interests may be selected and displayed, the user's items for sale may be selected and displayed, or items on the user's wish list may be selected and displayed.

The showcase gallery may display a set of items owned by the user. The user may have specified which items of the user's inventory are in the showcase gallery. Each item description 1820A-1820H (collectively, item descriptions 1820) may include an image or text description of the item. An indicator 1830 shows that the item corresponding to the item description 1820A is for sale. The user may choose to allow other users to see the showcase gallery. Items in the showcase gallery may be categorized by the user, categorized by the network-based commerce system 105, left uncategorized, or any suitable combination thereof.

An area 1840 may display messages written by or sent to the user. For example, messages to the user DJ_INHALE regarding the items described in the item descriptions 1820 may be shown.

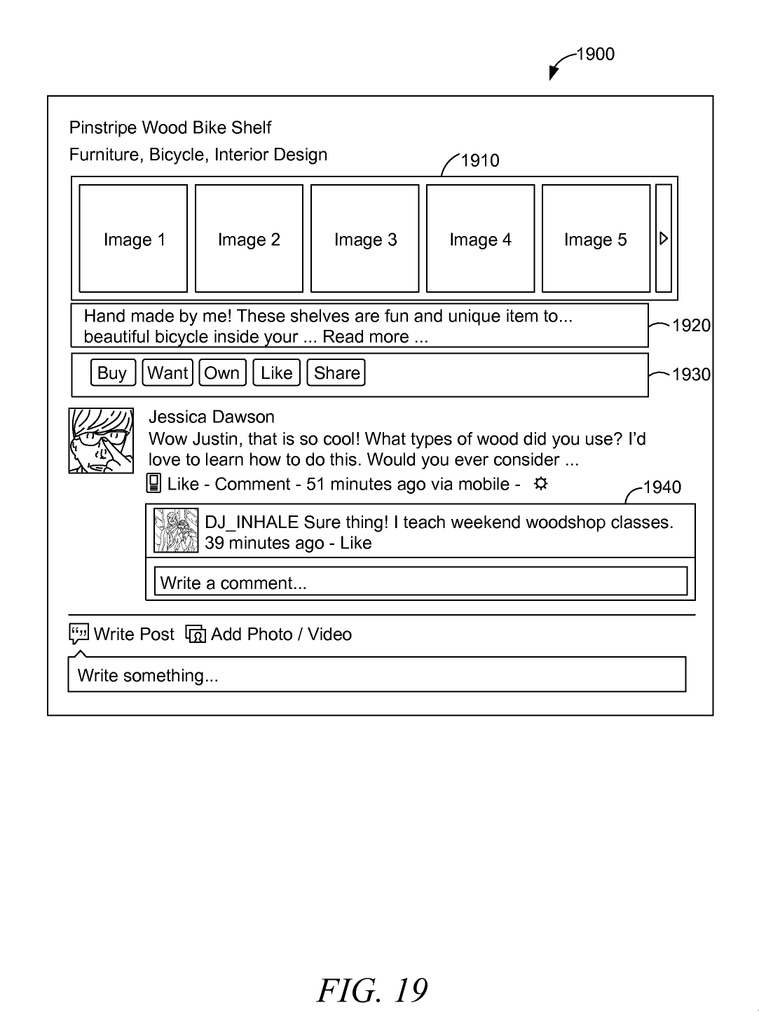

FIG. 19 is a UI diagram 1900 showing a user interface including comments on an item. In the UI diagram 1900, a user “Jessica Dawson” has commented on a “Pinstripe Wood Bike Shelf” item made available through the showcase gallery of user DJ_INHALE. An element 1910 contains five images of the item being commented on, along with an arrow operable to scroll the images, while element 1920 contains a text description of the item. An area 1930 contains five buttons. The button labeled “buy” may be operable to begin a transaction to buy the item. The button labeled “want” may be operable to add the item to a user's want list. The button labeled “own” may be operable to add the item to a user's inventory of owned items. The button labeled “like” may be operable to indicate that a user likes the item (e.g., on a social network). The button labeled “share” may be operable to share a link to the item description (e.g., on a social network). User DJ_INHALE may be able to view the comment via the showcase interface. Alternatively, the comment may be made available to the user DJ_INHALE via the user inventory interface. In some embodiments, the comment is sent to the user DJ_INHALE via a messaging system such as email. An element 1940 shows a response by the user DJ_INHALE and a prompt permitting the user to respond to the conversation thread.

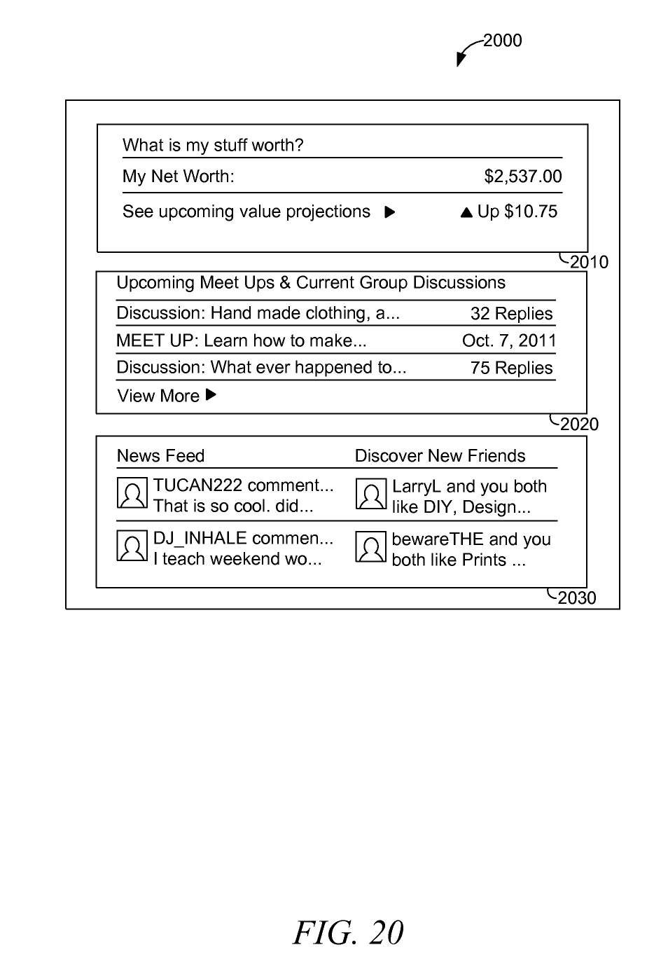

FIG. 20 is a UI diagram 2000 of a UI including a summary of information regarding a user's inventory. In an area 2010, the user's current net worth is shown along with an indication of how the net worth has changed. The change may be measured over a predetermined period of time, such as over the last year, last month, or since the last time the user checked the net worth. An element may be presented that is operable to show a projected future value of the user's net worth. In an area 2020, information regarding the user's upcoming meet ups and current group discussions is shown. For example, links to discussions the user is participating in may be shown along with an indicator of the popularity of each discussion. As another example, dates for upcoming meetings may be shown along with an element operable to show more information regarding each meeting. The meetings may be associated with groups that the user has joined.

An area 2030 shows news for the user, such as comments on threads the user is participating or news items related to the user's interests. Also shown in the area 2030 are two recommendations of new friends. As indicated in the UI 2000, the friend recommendations are based on shared interests. In the case of LarryL, both the user and the suggested new friend like “DIY” and “Design.” In the case of bewareTHE, both the user and the suggested new friend like “Prints.” Each of the liked things may be categories chosen by the respective users, descriptive words added by each user to a personal profile, or categories determined by the system from an analysis of items listed by each user (e.g., listed in a personal inventory, listed in a showcase, listed for sale, listed in a want list, or any suitable combination thereof).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

Furthermore, the tangible machine-readable medium is non-transitory in that it does not embody a propagating signal. However, labeling the tangible machine-readable medium as “non-transitory” should not be construed to mean that the medium is incapable of movement—the medium should be considered as being transportable from one physical location to another. Additionally, since the machine-readable medium is tangible, the medium may be considered to be a machine-readable device.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
receiving a record that indicates that an item is owned by a user;
receiving a user preference that indicates a target price at which the user is willing to sell the item;
receiving a record that indicates a current price for the item; and
based on the current price exceeding the target price, creating a listing of the item for sale by a processor of a machine.

2. The method of claim 1, wherein:
the record that indicates that the item is owned by the user further indicates a date on which the item was purchased by the user; and
the record that indicates that the item is owned by the user further indicates whether the item was new or used on the date.

3. The method of claim 2, further comprising storing the record that indicates that the item is owned by the user on the date on which the item was purchased by the user.

4. The method of claim 1, further comprising causing a user interface to be presented to the user, the user interface indicating the current price and the target price, the user interface including a confirmation option; and wherein
the creating of the listing is responsive to a selection of the confirmation option by the user.

5. The method of claim 1, further comprising causing a display of a price trend graph for the item, the price trend graph showing past prices of the item.

6. The method of claim 5, further comprising detecting an interaction of the user with an area of the price trend graph; and
causing the display of a past transaction for the item, the past transaction corresponding to the area of the price trend graph.

7. The method of claim 5, wherein the price trend graph includes multiple prices for a single date, each of the multiple prices corresponding to a transaction type.

8. The method of claim 7, wherein at least one of the transaction types is an auction transaction.

9. The method of claim 5, further comprising determining a condition of the item and wherein the past prices of the item are based on the condition of the item.

10. The method of claim 5, further comprising determining an edition of the item and wherein the past prices of the item are based on the edition of the item.

11. A system comprising:
one or more processors of one or more machines configured to:
receive a record that indicates that an item is owned by a user;
receive a record that indicates an expected future event;
correlate the expected future event with previous events;
determine that the expected future event is likely to have a negative impact on a value of the item; and
recommend to the user, using the processor of the machine, that the item be sold before the expected future event occurs.

12. The system of claim 11, wherein the recommending to the user that the item be sold includes causing display of a color-coded element indicating a strength of the recommendation.

13. The system of claim 11, wherein the recommending to the user that the item be sold includes display of a price distribution indicating a range of current prices for the item.

14. The system of claim 11, wherein the one or more processors of the one or more machines are further configured to:
retrieve a date on which the item was purchased by the user;
retrieve a current value of the item;
retrieve a value of the item on the date;
determine a change in value of the item based on the current value of the item and the value of the item on the date; and
wherein the recommending to the user that the item be sold includes causing a display of the change in value of the item.

15. The system of claim 11, wherein the expected future event is a release of a replacement item for the item.

16. The system of claim 11, wherein the one or more processors of the one or more machines are further configured to:
receive an acceptance of the recommendation from the user; and
responsive to the receiving of the acceptance, create a listing of the item for sale.

17. A non-transitory machine-readable storage medium comprising instructions that, when executed by one or more processors of a machine, cause the machine to perform operations comprising:
receiving a record that indicates that an item is owned by a user;
receiving a user preference that indicates a target price at which the user is willing to sell the item;
receiving a record that indicates a current price for the item; and
based on the current price exceeding the target price, creating a listing of the item for sale by a processor of a machine.

18. The non-transitory machine-readable storage medium of claim 17, wherein:
the record that indicates that the item is owned by the user further indicates a date on which the item was purchased by the user; and
the record that indicates that the item is owned by the user further indicates whether the item was new or used on the date.

19. The non-transitory machine-readable storage medium of claim 18, wherein the operations further comprise storing the record that indicates that the item is owned by the user on the date one which the item was purchased by the user.

20. The non-transitory machine-readable storage medium of claim 18, wherein the operations further comprise causing a user interface to be presented to the user, the user interface indicating the current price and the target price, the user interface including a confirmation option; and wherein
the creating of the listing is responsive to a selection of the confirmation option by the user.
